(19) United States
(12) Patent Application Publication
(10) Pub. No.: US 2019/0061857 A1
(43) Pub. Date: Feb. 28, 2019

(54) EYEGLASS-CARRYING DEVICES FOR BICYCLES AND/OR SIMILAR TUBULAR BODIES AND BICYCLES PROVIDED WITH SUCH EYEGLASS-CARRYING DEVICES

(71) Applicant: KASK S.p.A., Chiuduno (BG) (IT)

(72) Inventor: Angelo GOTTI, Nembro (BG) (IT)

(21) Appl. No.: 16/108,720

(22) Filed: Aug. 22, 2018

(30) Foreign Application Priority Data
Aug. 24, 2017 (IT) 102017000095851

(51) Int. Cl. B62J 11/00; B60R 7/08

(52) U.S. Cl. CPC B62J 11/00; A45F 2200/0541; B60R 7/082

(57) ABSTRACT

An eyeglass-carrying device for bicycles and/or similar tubular bodies may include: at least one engagement portion provided with at least one fastening mechanism configured to grip a pair of eyeglasses to hold the eyeglasses in a predetermined position; at least one supporting portion provided with at least one supporting surface configured to engage a destination surface of a frame of a bicycle and/or of a similar tubular body; at least one locking element configured to operatively associate with the at least one supporting portion to keep the eyeglass-carrying device engaged to the destination surface of the frame of the bicycle and/or of the similar tubular body; and at least one fastening protuberance configured to removably engage the at least one locking element and configured to lock the eyeglass-carrying device on the destination surface of the frame of the bicycle and/or of the similar tubular body.

The present invention refers to an eyeglass carrying device for bicycles.

Another object of the present invention is a bicycle provided with the aforementioned eyeglass carrying device.

The object of the present invention lends itself to being used in the field of sports and has particular use in the field of cycling both at amateur and competitive level.

As known, during any sports activity of the cycling type, the athletes and/or cyclists can be provided with and use various accessories that, when not being used, need to be stably arranged so that they do not interfere with the normal athletic and/or physical activity being carried out.

With particular reference to eyeglasses intended for protecting the eyes of athletes and/or cyclists from sunlight, from rain, from wind, from air resistance, from insects and from undesired contact with foreign bodies, the passage from a usage condition to a non-use condition thereof during the sporting activity, especially when competitive, requires the athlete and/or cyclist to search for a safe place in which to momentarily and stably place the removed eyeglasses.

Generally, once removed, the eyeglasses are inserted in a pocket made in the sports clothing of the athlete and/or cyclist.

The act of removing the eyeglasses from the face of the athlete and/or cyclist and the positioning thereof inside a pocket requires a series of manual actions that significantly disturb the performance of the athletic and physical activity being carried out and has some risks in terms of safety.

In particular, the aforementioned operation can be carried out in two different ways that both require that one or even both of the hands be removed from the handlebar of the bicycle.

In a first case the athlete and/or the cyclist, must take a hand off the handlebar to grip the eyeglasses and remove them from the face. Since the athlete and/or the cyclist has to insert the eyeglasses in a respective pocket, the size of which is generally small and the position of which is normally located on a side or on the back of the athlete and/or cyclist, it is necessary to close up the eyeglasses, folding the respective temples, so that they take up a low-bulk configuration. The folding of the temples can be ably carried out using a single hand with the risk that the eyeglasses may slip or fall as the bicycle moves forwards.

In a second case, once the eyeglasses have been removed from the face with one hand, the athlete and/or the cyclist takes the other hand off the handlebar to quickly fold the temples and take the eyeglasses into a minimum-bulk configuration useful for the insertion thereof inside the aforementioned pocket. The handling of the eyeglasses with two hands involves a high accident risk for the athlete and/or the cyclist since, by temporarily leaving the handlebar, he/she rides the bicycle with only the balance of his/her body.

The act of repositioning the eyeglasses on the face of the athlete and/or cyclist also requires a series of movements that disturb the performance of the athletic and physical activity, with accident risks for him/her. In other situations, instead of inserting the eyeglasses in the respective pockets made in the garments used, the athletes and/or cyclists can place the eyeglasses on the helmets by inserting the temples of the eyeglasses inside the corresponding aeration openings. These operations of finding the aeration openings most suitable for accommodating the temples of the eyeglasses, as well as the insertion of such temples in the selected openings, also inevitably require the athletes and/or cyclists to use both hands, with clear risks to their safety.

In the case in which the athletes and/or cyclists do not have either suitable pockets made in the garments used, nor helmets provided with aeration openings suitable for receiving the respective temples inserted in them, the removal of the eyeglasses from the face is normally carried out and they are kept in raised position on the forehead, collecting sweat and/or condensation.

In addition, it should be noted that all of the removal operations of the eyeglasses from the face of athletes and/or cyclists like those relative to the repositioning of the eyeglasses onto the face are generally carried out during races and/or similar competitions in which it is necessary to maintain one's concentration and not be distracted by possible impediments that can arise through the handling of the eyeglasses.

The main purpose of the present invention is to provide an eyeglass carrying device for bicycles and similar tubular bodies, as well as a bicycle provided with such an eyeglass carrying device, capable of solving the problems encountered in the prior art.

A further purpose of the present invention is to propose an eyeglass carrying device for bicycles and similar tubular bodies, as well as a bicycle provided with such an eyeglass carrying device, which allow the eyeglasses worn by an athlete and/or cyclist to be positioned in a single operation or through a limited number of operations.

Another purpose of the present invention is to propose an eyeglass carrying device for bicycles and similar tubular bodies, as well as a bicycle provided with such an eyeglass carrying device, which allow the quick and simple positioning of the eyeglasses worn by an athlete and/or a cyclist using a single hand.

Another purpose of the present invention is to propose an eyeglass carrying device for bicycles and similar tubular bodies, as well as a bicycle provided with such an eyeglass carrying device, capable of ensuring the stable positioning of the eyeglasses worn by an athlete and/or cyclist according to a predetermined position.

Finally, a purpose of the present invention is to propose an eyeglass carrying device for bicycles and similar tubular bodies, as well as a bicycle provided with such an eyeglass carrying device, which allow the immediate positioning of the eyeglasses worn by an athlete and/or cyclist in total safety.

The purposes specified above, and yet others, are substantially achieved by an eyeglass carrying device for bicycles and similar tubular bodies, as well as a bicycle provided with such an eyeglass carrying device, as expressed and described in the following claims.

The description of a preferred, but not exclusive, embodiment of an eyeglass carrying device for bicycles and similar tubular bodies, as well as a bicycle provided with such an eyeglass carrying device, in accordance with the present invention, will now be given, as an example. Such a description will be carried out hereinafter with reference to the attached drawings, provided for indicating and therefore not limiting purposes, in which:

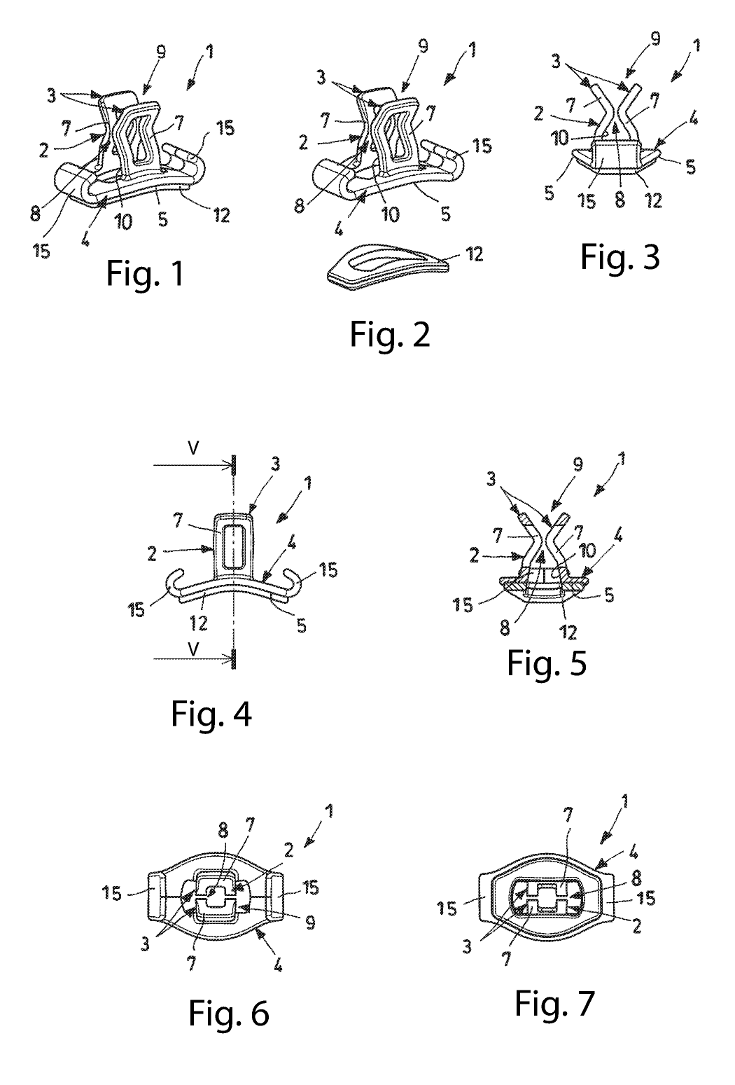

FIG. 1 is a perspective view of an eyeglass carrying device, in accordance with a first embodiment of the present invention;

FIG. 2 is an exploded perspective view of the eyeglass carrying device according to FIG. 1;

FIG. 3 is a front elevational view of the eyeglass carrying device according to FIGS. 1 and 2;

FIG. 4 is a side elevational view of the eyeglass carrying device according to FIGS. 1 to 3;

FIG. 5 is a section of the eyeglass carrying device according to FIGS. 1 to 4, carried out according to the line V-V of FIG. 4;

FIG. 6 is a plan view of the eyeglass carrying device according to FIGS. 1 to 5;

FIG. 7 is a view from below of the eyeglass carrying device according to FIGS. 1 to 6;

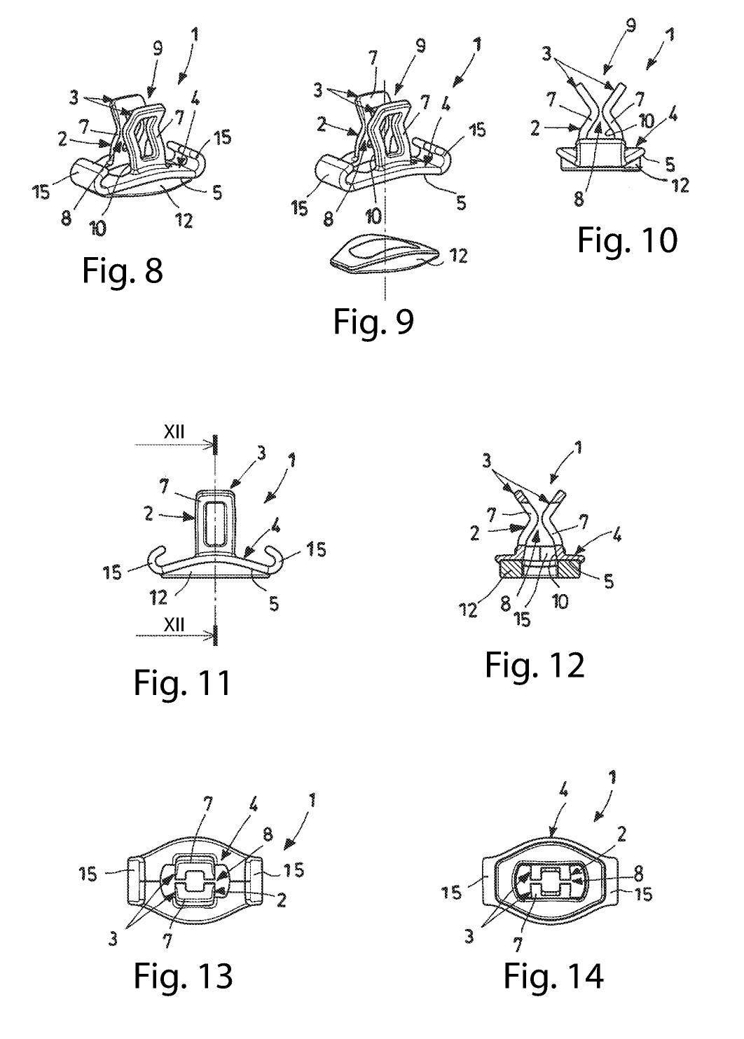

FIG. 8 is a perspective view of an eyeglass carrying device, in accordance with a second embodiment of the present invention;

FIG. 9 is an exploded perspective view of the eyeglass carrying device according to FIG. 8;

FIG. 10 is a front elevational view of the eyeglass carrying device according to FIGS. 8 and 9;

FIG. 11 is a side elevational view of the eyeglass carrying device according to FIGS. 8 to 10;

FIG. 12 is a section of the eyeglass carrying device according to FIGS. 8 to 11, carried out according to the line XII-XII of FIG. 11;

FIG. 13 is a plan view of the eyeglass carrying device according to FIGS. 8 to 12;

FIG. 14 is a view from below of the eyeglass carrying device according to FIGS. 8 to 13;

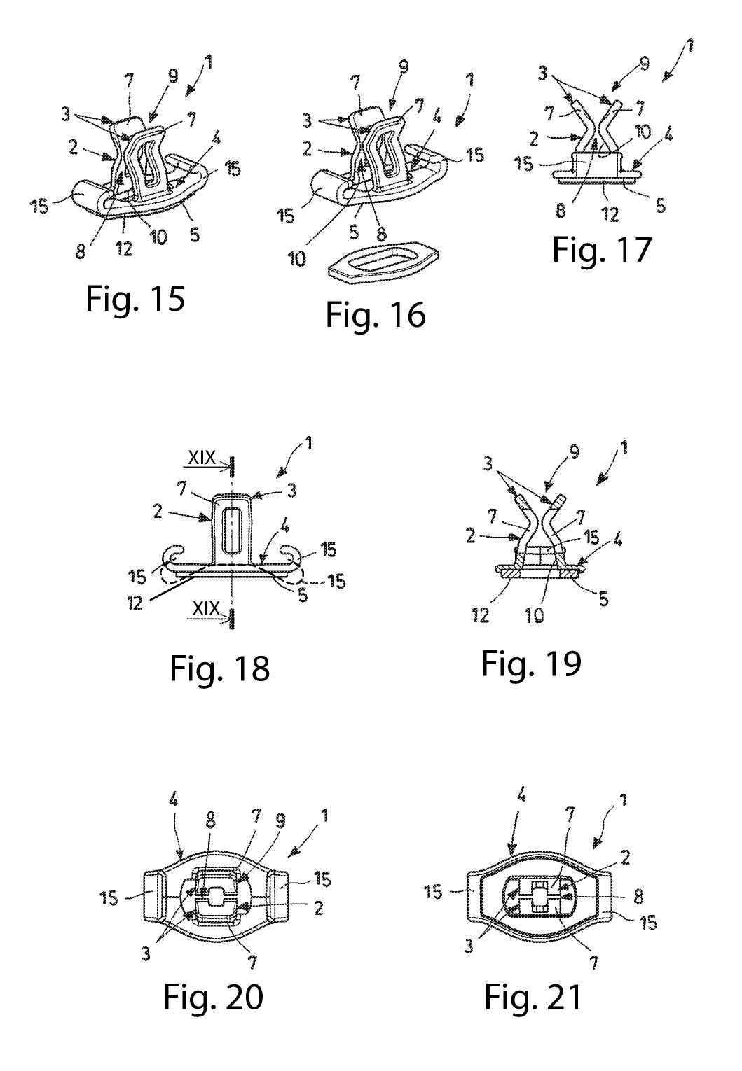

FIG. 15 is a perspective view of an eyeglass carrying device, in accordance with a third embodiment of the present invention;

FIG. 16 is an exploded perspective view of the eyeglass carrying device according to FIG. 15;

FIG. 17 is a front elevational view of the eyeglass carrying device according to FIGS. 15 and 16;

FIG. 18 is a side elevational view of the eyeglass carrying device according to FIGS. 15 to 17;

FIG. 19 is a section of the eyeglass carrying device according to FIGS. 15 to 18, carried out according to the line XIX-XIX of FIG. 18;

FIG. 20 is a plan view of the eyeglass carrying device according to FIGS. 15 to 19;

FIG. 21 is a view from below of the eyeglass carrying device according to FIGS. 15 to 20;

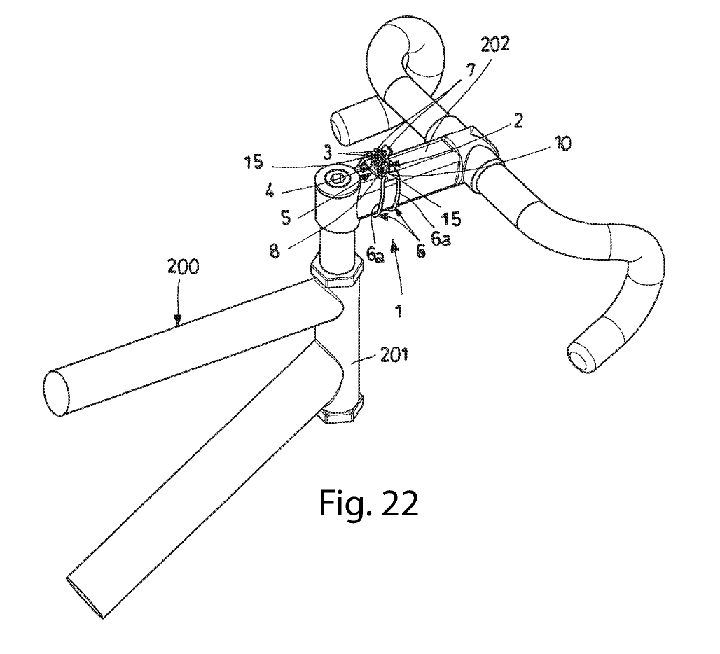

FIG. 22 is a perspective view of the eyeglass carrying device according to FIGS. 1 to 21 applied onto a frame of a bicycle;

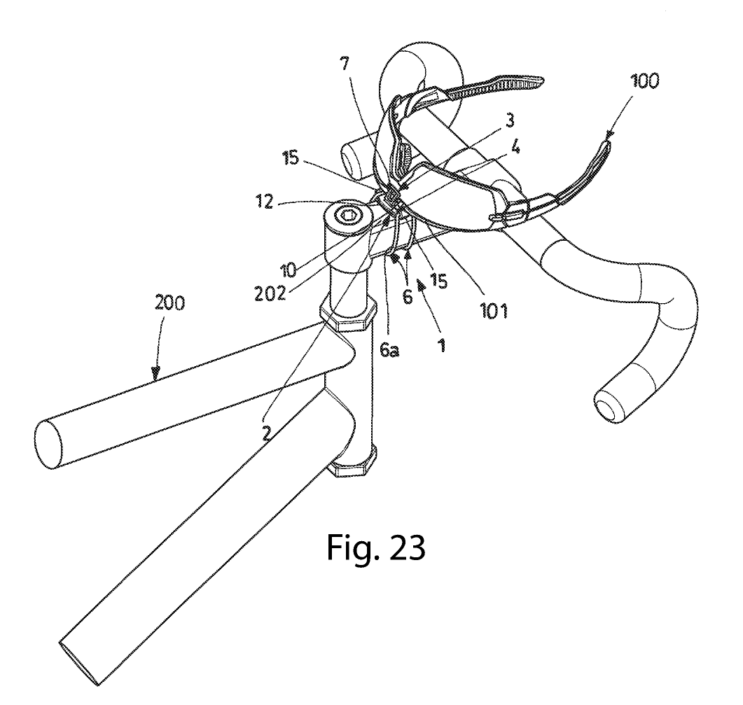

FIG. 23 is a perspective view of the eyeglass carrying device according to FIGS. 1 to 22 applied onto a frame of a bicycle and fastened to a pair of glasses;

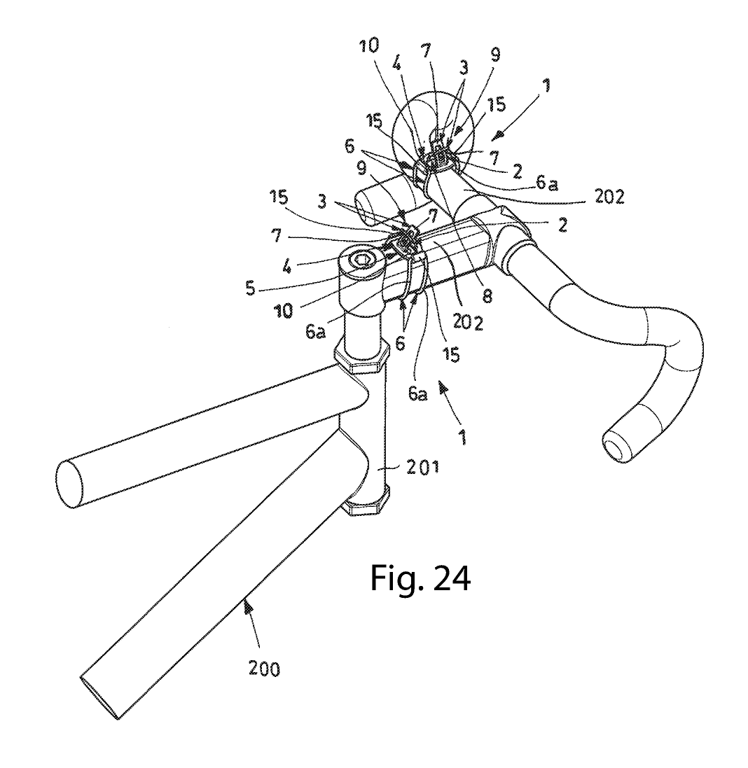

FIG. 24 is a perspective view of two eyeglass carrying devices like the one depicted in FIGS. 1 to 23, one applied onto a frame of a bicycle, the other onto the handlebar thereof;

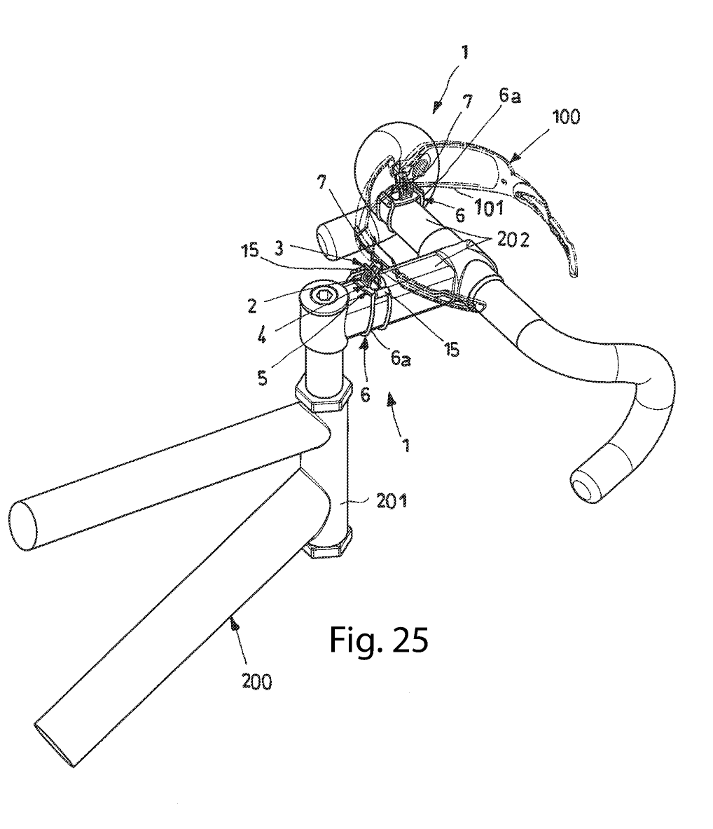

FIG. 25 is a perspective view of the eyeglass carrying devices illustrated in FIG. 24 both fastened to a respective portion of a pair of eyeglasses;

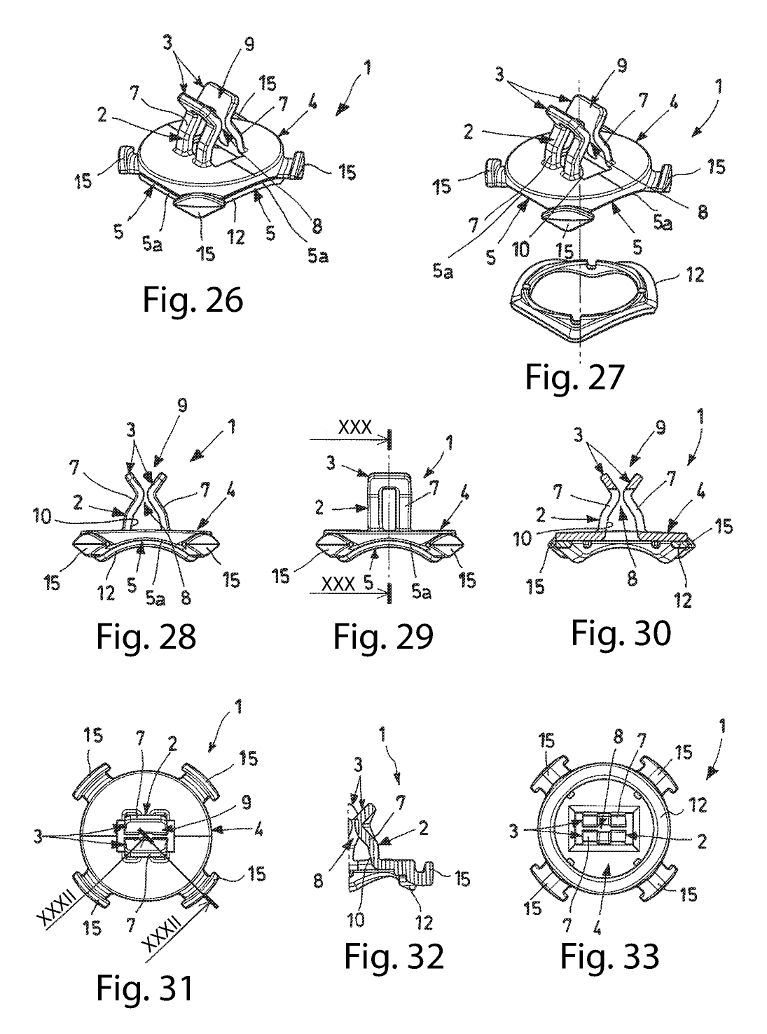

FIG. 26 is a perspective view of an eyeglass carrying device, in accordance with a fourth embodiment of the present invention;

FIG. 27 is an exploded perspective view of the eyeglass carrying device according to FIG. 26;

FIG. 28 is a front elevational view of the eyeglass carrying device according to FIGS. 26 and 27;

FIG. 29 is a side elevational view of the eyeglass carrying device according to FIGS. 26 to 28;

FIG. 30 is a section of the eyeglass carrying device according to FIGS. 26 to 29 carried out along the line XXX-XXX of FIG. 29;

FIG. 31 is a plan view of the eyeglass carrying device according to FIGS. 26 to 30;

FIG. 32 is a half-section of the eyeglass carrying device according to FIGS. 26 to 31, carried out along the line XXXII-XXXII of FIG. 31;

FIG. 33 is a view from below of the eyeglass carrying device according to FIGS. 26 to 32;

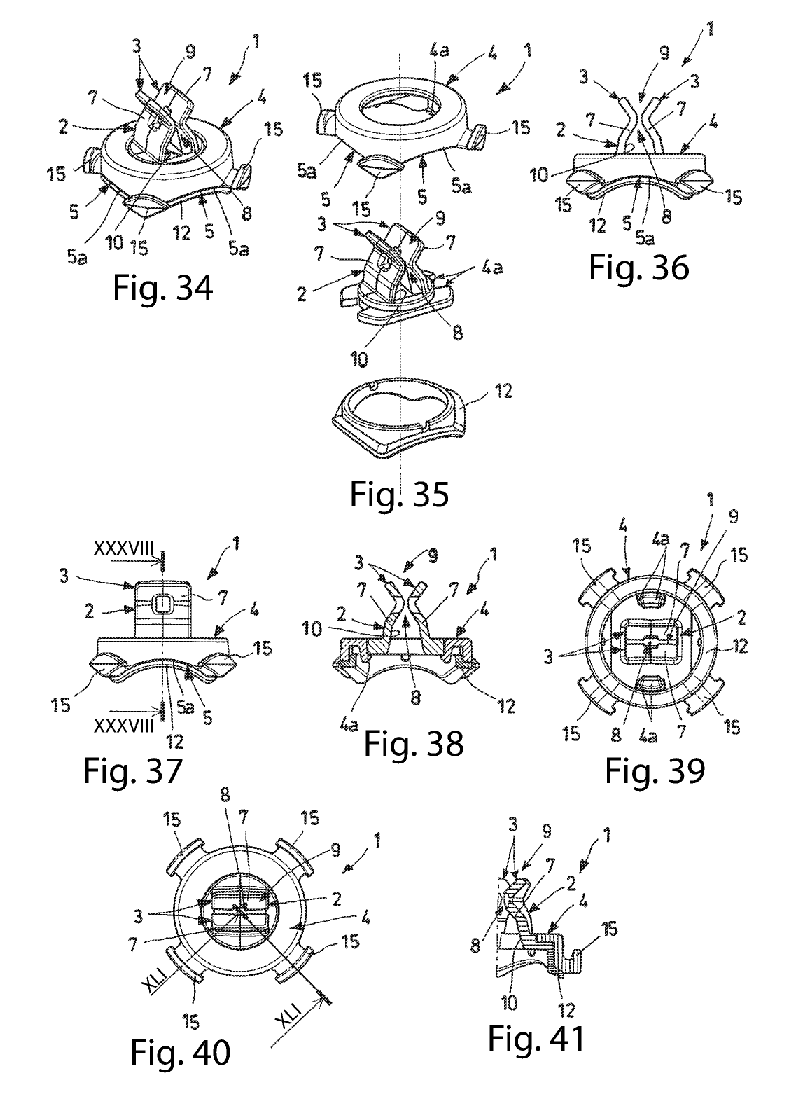

FIG. 34 is a perspective view of an eyeglass carrying device, in accordance with a fifth embodiment of the present invention;

FIG. 35 is an exploded perspective view of the eyeglass carrying device according to FIG. 34;

FIG. 36 is a front elevational view of the eyeglass carrying device according to FIGS. 34 and 35;

FIG. 37 is a side elevational view of the eyeglass carrying device according to FIGS. 34 to 36;

FIG. 38 is a section of the eyeglass carrying device according to FIGS. 34 to 37 carried out along the line XXXVIII-XXXVIII of FIG. 37;

FIG. 39 is a view from below of the eyeglass carrying device according to FIGS. 34 to 38;

FIG. 40 is a plan view of the eyeglass carrying device according to FIGS. 34 to 39;

FIG. 41 is a half-section of the eyeglass carrying device according to FIGS. 34 to 40, carried out according to the line XLI-XLI of FIG. 40;

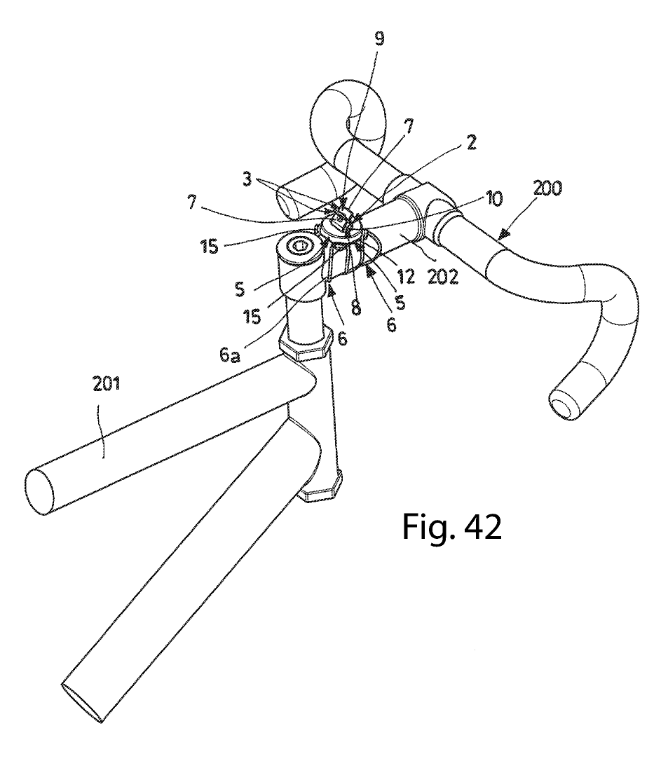

FIG. 42 is a perspective view of the eyeglass carrying device according to FIGS. 34 to 41 applied onto a frame of a bicycle, in accordance with the present invention;

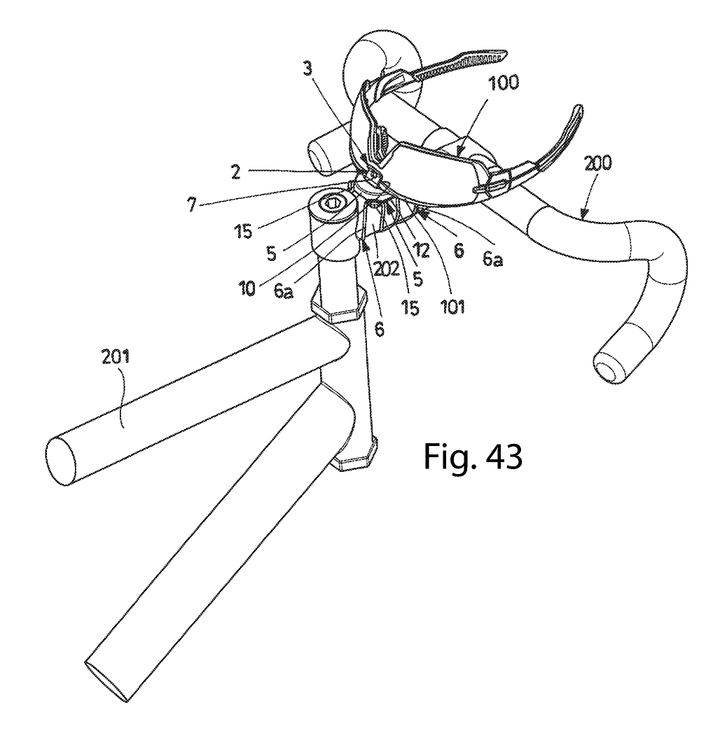

FIG. 43 is a perspective view of the eyeglass carrying device according to FIGS. 34 to 43 applied onto a frame of a bicycle and fastened to a pair of eyeglasses;

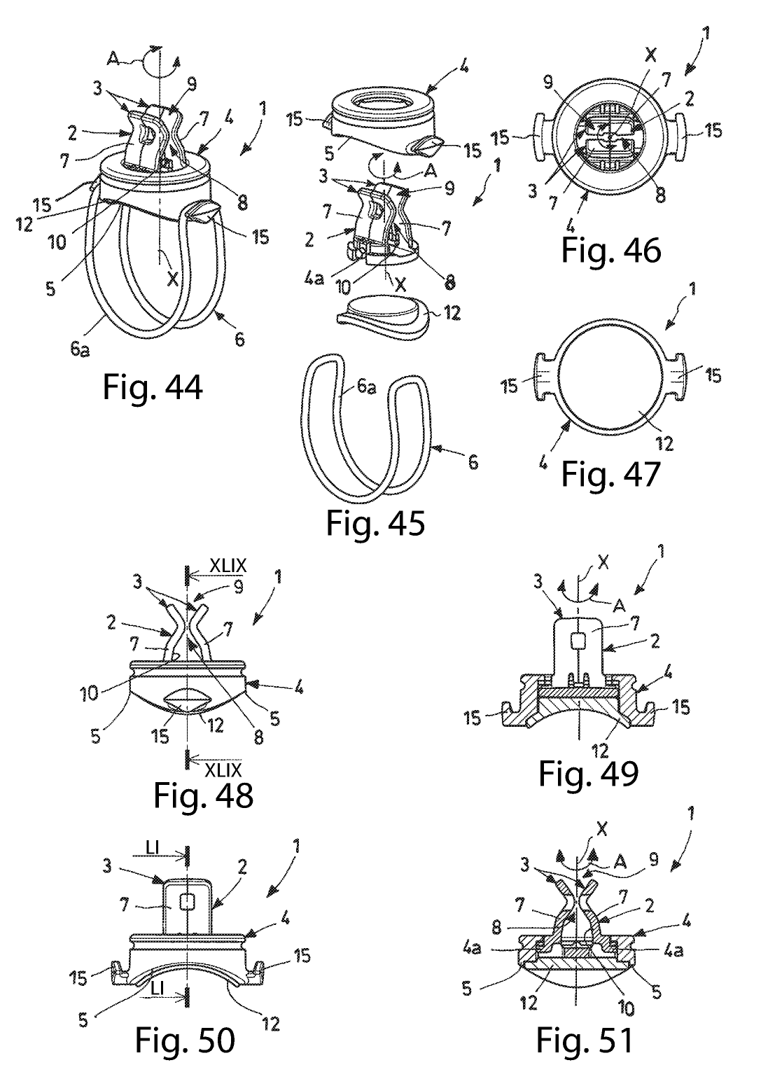

FIG. 44 is a perspective view of an eyeglass carrying device, in accordance with a sixth embodiment of the present invention;

FIG. 45 is an exploded perspective view of the eyeglass carrying device according to FIG. 44;

FIG. 46 is a plan view of the eyeglass carrying device according to FIGS. 44 and 45;

FIG. 47 is a view from below of the eyeglass carrying device according to FIGS. 44 to 46;

FIG. 48 is a front elevational view of the eyeglass carrying device according to FIGS. 44 to 47;

FIG. 49 is a section of the eyeglass carrying device according to FIGS. 44 to 48, carried out according to the line XLIX-XLIX of FIG. 48;

FIG. 50 is a side elevational view of the eyeglass carrying device according to FIGS. 44 to 49;

FIG. 51 is a section of the eyeglass carrying device according to FIGS. 44 to 50, carried out according to the line LI-LI of FIG. 50;

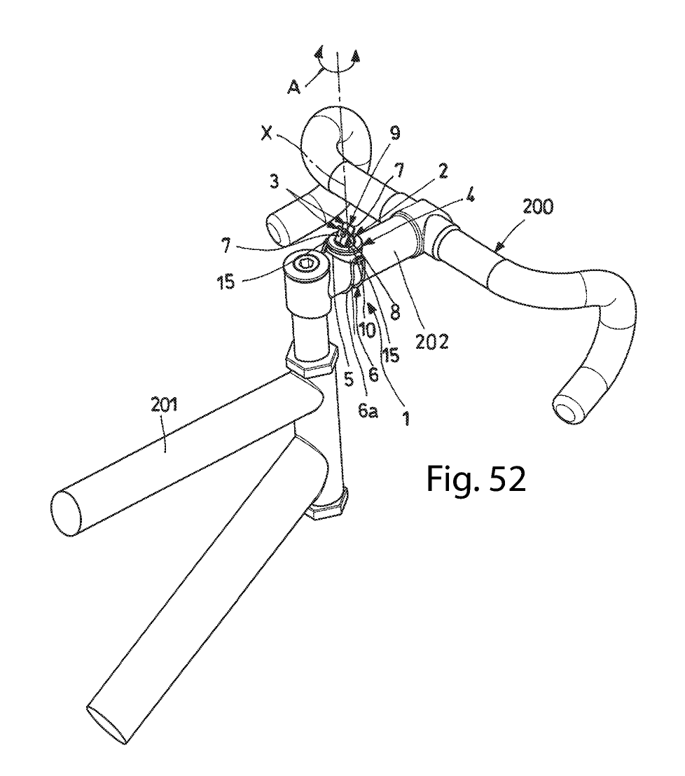

FIG. 52 is a perspective view of the eyeglass carrying device according to FIGS. 44 to 41 applied onto a frame of a bicycle, in accordance with the present invention;

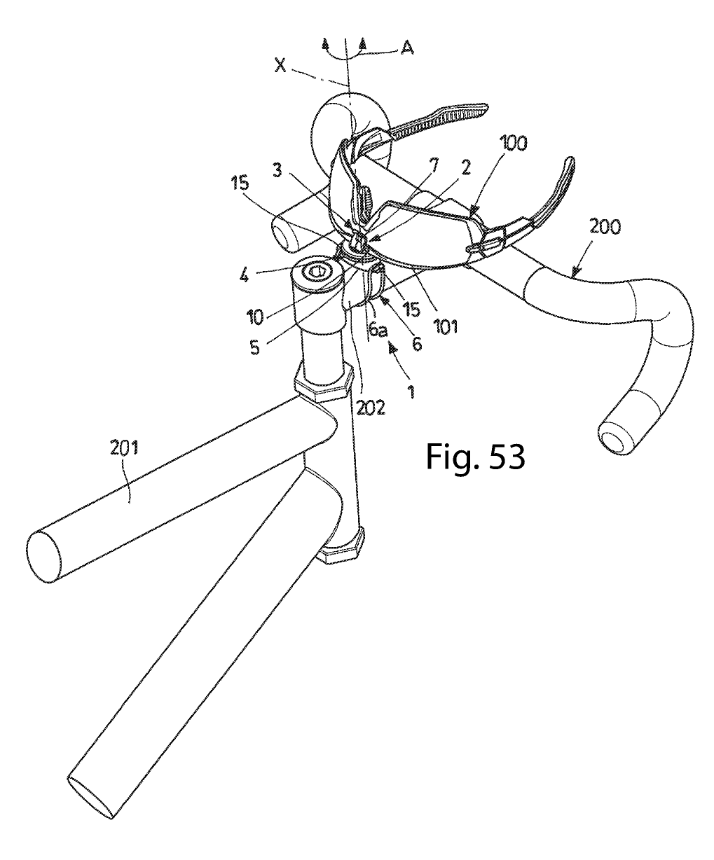

FIG. 53 is a perspective view of the eyeglass carrying device according to FIGS. 44 to 52 applied onto a frame of a bicycle and fastened to a pair of eyeglasses;

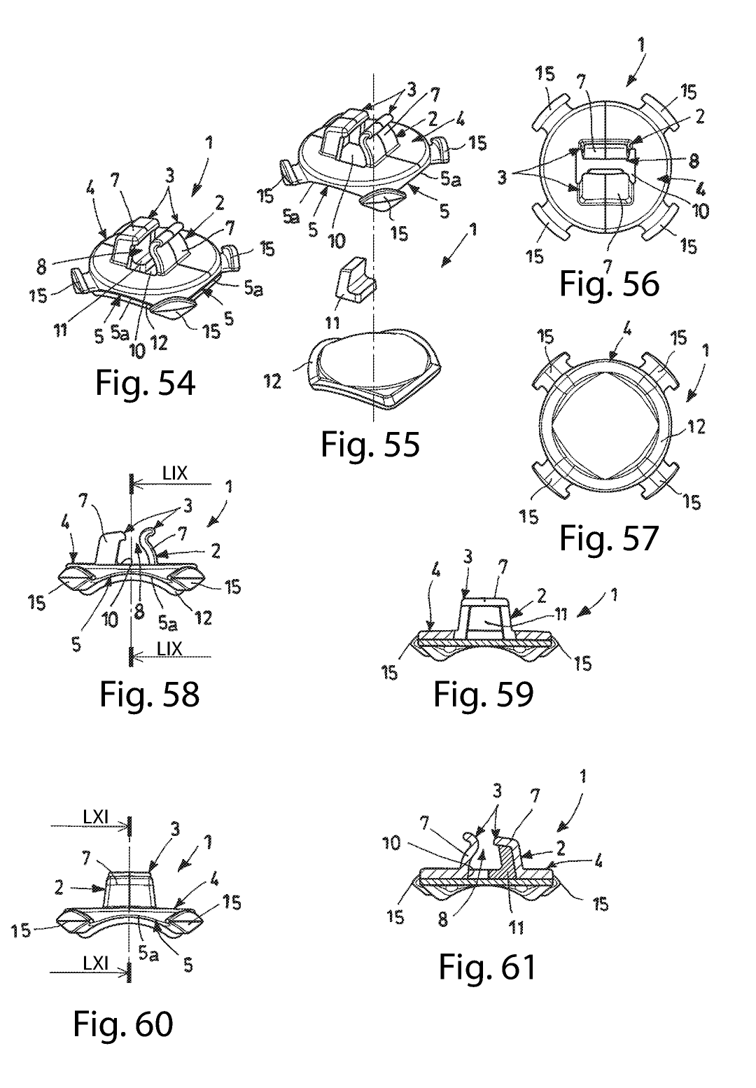

FIG. 54 is a perspective view of an eyeglass carrying device, in accordance with a seventh embodiment of the present invention;

FIG. 55 is an exploded perspective view of the eyeglass carrying device according to FIG. 54;

FIG. 56 is a plan view of the eyeglass carrying device according to FIGS. 54 and 55;

FIG. 57 is a view from below of the eyeglass carrying device according to FIGS. 54 to 56;

FIG. 58 is a front elevational view of the eyeglass carrying device according to FIGS. 54 to 57;

FIG. 59 is a section of the eyeglass carrying device according to FIGS. 54 to 58, carried out according to the line LIX-LIX of FIG. 58;

FIG. 60 is a side elevational view of the eyeglass carrying device according to FIGS. 54 to 59;

FIG. 61 is a section of the eyeglass carrying device according to FIGS. 54 to 60, carried out according to the line LXI-LXI of FIG. 60;

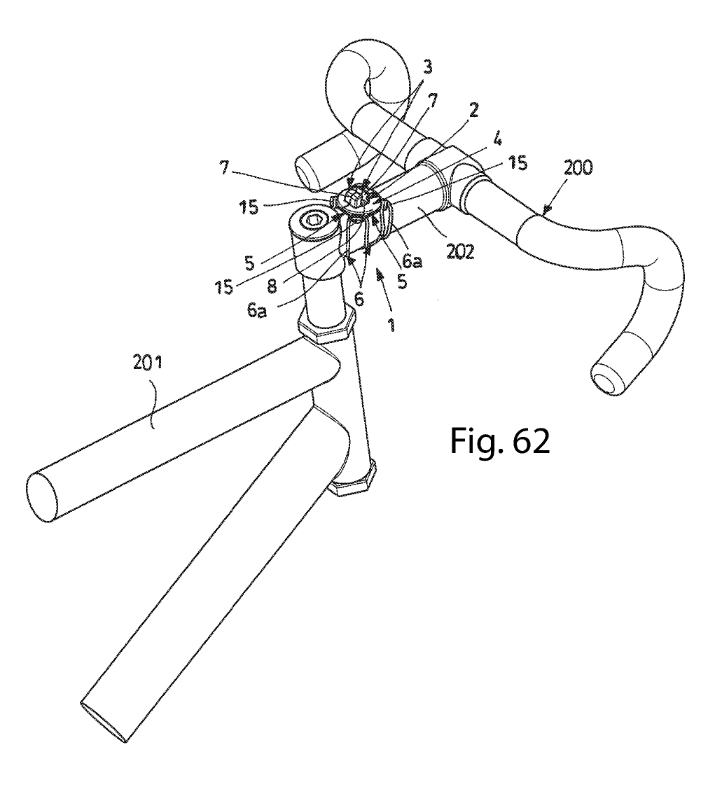

FIG. 62 is a perspective view of the eyeglass carrying device according to FIGS. 54 to 61 applied onto a frame of a bicycle, in accordance with the present invention;

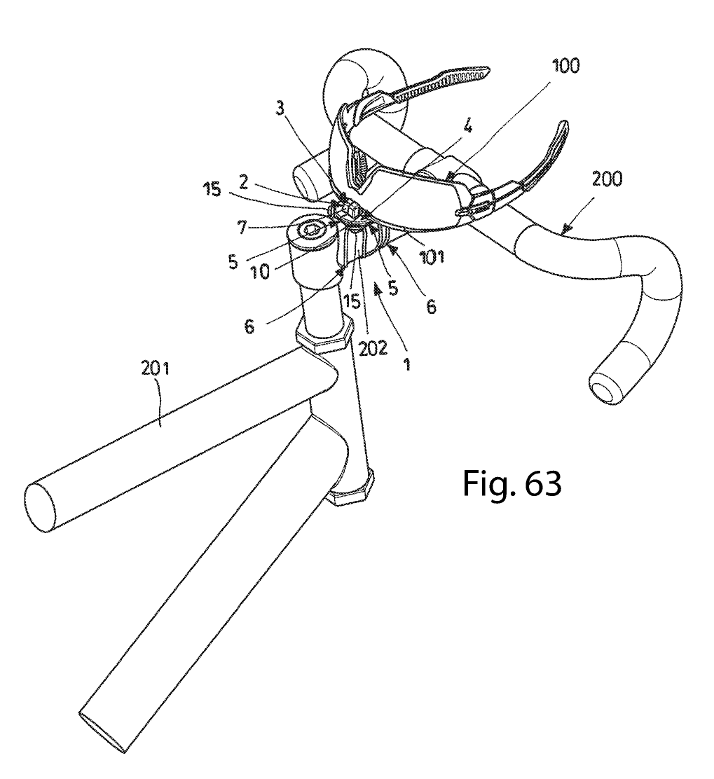

FIG. 63 is a perspective view of the eyeglass carrying device according to FIGS. 54 to 62 applied onto a frame of a bicycle and fastened to a pair of glasses;

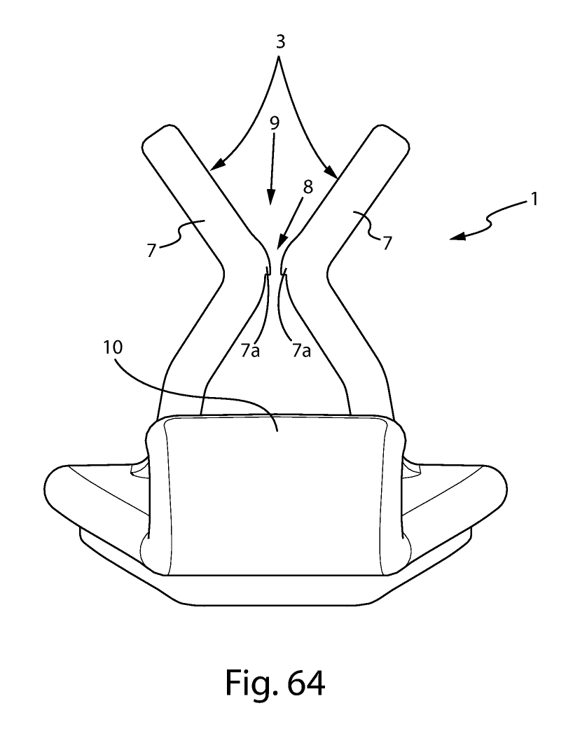

FIG. 64 is a detail of the eyeglass carrying device according to the previous figures according to a further embodiment thereof.

With reference to the attached figures, reference numeral 1 wholly indicates an eyeglass carrying device for bicycles and similar tubular bodies, in accordance with the present invention.

As can be seen in the attached figures, the eyeglass carrying device 1 comprises at least one engagement portion 2 provided with at least one fastening mechanism 3 arranged to grip a portion 101 (FIGS. 22 to 25, 42, 43, 52, 53, 62 and 63), preferably, but not exclusively, the bridge, of a pair of eyeglasses 100 (FIGS. 23, 25, 43, 53 and 63) to hold them in a predetermined position.

The portion 101 of the eyeglasses 100, able to be gripped by the fastening mechanism 3 of the eyeglass carrying device 1, can be different from the bridge, like for example the temples or the lenses.

The eyeglass carrying device 1 also comprises at least one supporting portion 4, preferably made on the opposite side with respect to the engagement portion 2, provided with at least one supporting surface 5 adapted for engaging a destination surface 202 of a frame 201 of a bicycle 200 and/or of a similar tubular body not forming part of the eyeglass carrying device 1.

The eyeglass carrying device 1 comprises at least one locking element 6 able to be operatively associated with the supporting portion 4 to keep the eyeglass carrying device itself engaged at the destination surface 202 of the frame 201 of the bicycle 200 and/or at the similar tubular body not forming part of the eyeglass carrying device 1.

With reference to the embodiments illustrated in FIGS. 1 to 53, the fastening mechanism 3 of the engagement portion 2 of the eyeglass carrying device 1 comprises at least one pair of fastening appendages 7 each developing from the supporting portion 4 to converge towards a common convergence point 8 in which such fastening appendages 7 are close to one another or in contact with each other.

With reference to the embodiments illustrated in FIGS. 1 to 53, the fastening appendages 7 diverge from one another going away from the convergence point 8 and on the opposite side to the supporting portion 4 to define a facilitating groove 9 for the engagement of the portion 101 of the eyeglasses 100.

In detail, the fastening appendages 7 at least partially delimit a housing and locking seat 10 of the portion 101 of the eyeglasses 100 to be fastened and held.

Advantageously, the fastening appendages 7 are elastically deformable to allow the insertion of the aforementioned portion 101 of the eyeglasses 100 in the respective housing and locking seat 10, as well as the extraction and disengagement of the portion 101 from such a housing and locking seat 10 through the opening out of the fastening appendages 7, or, possibly, of mobile parts of the latter, at the convergence point 8. According to a further advantageous aspect of the present invention, the eyeglass carrying device 1 can be provided with suitable abutment and holding surfaces 7a (FIG. 64) made on each of the fastening appendages 7 at the convergence point 8 to provide at least one abutment surface for the eyeglasses 100 housed in the respective housing and locking seat 10 and counteract the accidental disengagement thereof.

More in particular, the abutment surfaces 7a face towards the housing and locking seat 10 so as to hold the eyeglasses 100 in such a seat during the sports activity.

Alternatively, as can be seen in the embodiment illustrated in FIGS. 54 to 63, the housing and locking seat 10 is provided with at least one magnetic element 11 capable of interacting with at least one respective magnetic element (not represented in the attached figures) or ferromagnetic element present on the portion 101 of the eyeglasses 100 to be fastened to hold the latter in the desired position.

Advantageously, the magnetic and/or ferromagnetic element arranged on the eyeglasses 100 and adapted for interacting with the magnetic element 11 of the eyeglass carrying device 1, can be engaged, fitted or incorporated directly in the bridge/nosepad and/or in the temples and/or in the lenses of the eyeglasses used so as to allow different couplings between the latter and the eyeglass carrying device 1 provided.

Again with reference to the embodiment illustrated in FIGS. 54 to 63, the housing and locking seat 10 is delimited, at least partially, by a pair of fastening appendages 7 that develop from the supporting portion 4 and at least one of which converges towards the other at a convergence point 8.

Advantageously, the fastening appendage 7 that converges towards the other fastening appendage 7 is elastically deformable to allow a snap-insertion of the respective portion 101 of the eyeglasses 100 in the housing and locking seat 10, at which such a portion 101 is held by the magnetic element 11.

With reference to the embodiments illustrated in FIGS. 1, 2, 4, 8, 9, 11, 26-30, 34-38, 44, 45, 49, 50, 54, 55 and 58-61, the supporting surface 5 of the supporting portion 4 of the eyeglass carrying device 1 is arched, preferably concave, to engage a respective arched convex destination surface 202 of the frame 201 of the bicycle 200 and/or a similar tubular portion arched convex.

With reference to the embodiments illustrated in FIGS. 16 to 19, the supporting surface 5 of the supporting portion 4 of the eyeglass carrying device 1 is flat to engage a flat destination surface 202 of the frame 201 of the bicycle 200 and/or a similar flat tubular portion.

Again with reference to the embodiments illustrated in FIGS. 16 to 19, the supporting surface 5 of the supporting portion 4 of the eyeglass carrying device 1 has a variable configuration, schematised graphically with a dashed line in FIG. 18.

In particular, the supporting surface 5 can be switched between an arched concave configuration to engage an arched convex destination surface 202 of the frame 201 of the bicycle 200 and/or a similar arched convex tubular portion and a flat configuration, FIGS. 15 to 17 and 19, to engage a flat destination surface 202 of the frame 201 of the bicycle 200 and/or a similar flat tubular portion.

Going into greater detail, the supporting surface 5 with variable configuration is defined on an elastically deformable supporting portion 4. The elasticity of the supporting portion 4 allows the elastic deformation thereof as well as the switching of the supporting surface 5 between the arched concave configuration and the flat configuration. This characteristic is very advantageous since it gives the eyeglass carrying device the ability to adapt perfectly to the outer profile of the destination surface 202 of the frame 201 of the bicycle 200 and/or of the similar tubular portion, therefore being universal.

In order to ensure a satisfactory level of adherence between the supporting portion 4 of the eyeglass carrying device 1 and the destination surface 202 of the frame 201 of the bicycle 200 and/or of the similar tubular portion, the eyeglass carrying device 1 is advantageously provided with a gasket 12 or a similar interposition element (FIGS. 2, 4, 7-12, 14-19, 21-23, 26-30, 32-38, 41-45, 47-51, 54, 55, 57-61).

The gasket 12 can be interposed between the supporting surface 5 of the supporting portion 4 and the destination surface 202 of the frame 201 of a bicycle 200 and/or a similar tubular portion.

Advantageously, the gasket 12 has a first surface 12a, preferably counter-shaped to the supporting surface 5 of the supporting portion 4, so as to adhere and couple perfectly with the latter and a second surface 12b, facing the opposite way to the first surface 12a that can be arched concave shaped to adhere on an arched convex destination portion 202 of the frame 201 of the bicycle 200, or flat, to adhere on a flat destination portion 202 of the frame 201 of the bicycle 200.

Depending on the configuration of the supporting surface 5 of the supporting portion 4 provided, the gasket 12 can be arched concave shaped, flat or can have variable configuration between arched concave shaped or flat.

Advantageously, the gasket 12 is made of an elastically deformable material, preferably EPDM, in other words peroxide (Ethylene-Propylene-Diene-Monomer), to adapt, on one side, to the shape of the supporting surface 5 of the supporting portion 4 and, on the other side, to the shape of the destination surface 202 of the frame 201 of the bicycle 200 and/or of a similar tubular portion.

With reference to the embodiments illustrated in FIGS. 1-33 and 54-63, the fastening mechanism 3 of the engagement portion 2 is joined in one piece to the supporting portion 4 of the eyeglass carrying device 1 to constitute a single monoblock.

Alternatively, as illustrated in relation to the embodiments according to FIGS. 34-53, the engagement portion 2 provided with the fastening mechanism 3 can be removably constrained to the supporting portion 4 by means of suitable interlocking and/or snap engagement elements 4a.

In accordance with a further variant embodiment, the engagement portion 2 can be rotatably constrained to the supporting portion 4 so that the fastening appendages 7 are rotatable with respect to the latter, as represented by the curved arrow “A” represented in FIGS. 44, 52 and 53, around a respective rotation axis “X” that develops between the fastening appendages 7, substantially perpendicular to a reference plane tangent to the destination surface 202 of the frame 201 of the bicycle 200 in the intersection point between such a reference plane and the rotation axis “X”, allowing the positioning of the eyeglasses 100 on the bicycle 200 according to different angular positions with respect to the supporting portion 4.

With reference to the attached figures the eyeglass carrying device 1 is equipped with at least one fastening protuberance 15 for the removable engagement of the locking element 6 to the destination surface 202 of the frame 201 of the bicycle 200.

With particular reference to the embodiments illustrated in FIGS. 1-25 and 44-53, the eyeglass carrying device 1 is equipped with two opposite fastening protuberances 15 whereas the embodiments illustrated in FIGS. 26-43 and 54-63 provide for a plurality of fastening protuberance 15, preferably four, arranged substantially at the corners of a reference quadrilateral, namely one arranged at 90° with respect to the adjacent ones.

Irrespective of the number of fastening protuberances 15 provided, each of them is integrated in the supporting portion 4 developing from the latter, preferably cantilevered.

With reference to the embodiments illustrated in FIGS. 26-63, the supporting portion 4 of the eyeglass carrying device 1 has a substantially circular shape from which at least one of the aforementioned fastening protuberances 15, in particular all of them, develops, preferably cantilevered.

Again with reference to the embodiments illustrated in FIGS. 26-33, the supporting surface 5 of the supporting portion 4 is defined by a plurality of concave arched edges 5a, arranged opposite two-by-two according to a substantially square shape, so as to allow the same support of the eyeglass carrying device 1 on the destination surface 202 of the frame 201 of the bicycle 200 and/or of a similar tubular portion by rotating the entire body of the device 1 by 90°.

In accordance with the present invention, there is no reason why the supporting portion 4 of the eyeglass carrying device 1 cannot also have a substantially square or rectangular shape from which at least one of the aforementioned fastening protuberances 15, in particular all of them, develops, preferably cantilevered.

With reference to the embodiments illustrated in FIGS. 22-25, 42-45, 52, 53, 62 and 63, the locking element 6 has a substantially elongated structure in a closed loop, preferably wire-like in a closed loop, even more preferably an O-ring seal 6a, configured to at least partially surround the eyeglass carrying device 1 and keep it engaged to the destination surface 202 of the frame 201 of the bicycle 200 and/or of a similar tubular portion.

In detail, the O-ring seal 6a is configured to at least partially surround each of the fastening protuberances 15 projecting from the supporting portion 4 and keep the eyeglass carrying device 1 adhered to the destination surface 202 of the frame 201 of the bicycle 200 and/or of a similar tubular portion.

The eyeglass carrying device in accordance with the embodiments illustrated in FIGS. 1-21, 26-41, 46-50 and 54-61 is also configured to engage the frame 201 of the bicycle by using one or more O-ring seals 6a or similar elongated locking elements 6.

The eyeglass carrying device described above, as well as a bicycle equipped with such a device, solve the problems encountered in the prior art and achieve important advantages.

Firstly, the device described above allows athletes and/or amateur and/or competitive cyclists to position and lock the eyeglasses in use quickly on the frame of the bicycle with a single hand and without risks of accidents.

In particular, the device according to the present invention allows the quick and immediate locking of the eyeglasses on the frame, preferably on the handlebar stem of the bicycle without having to close the temples thereof. The locking action takes place by simply bringing to bridge of the eyeglasses used up to the housing and locking seat of the device and pressing it towards such a seat so as to force the eyeglasses and be gripped by the fastening mechanism of the engagement portion.

1. An eyeglass-carrying device for bicycles and/or similar tubular bodies, the eyeglass-carrying device comprising:
at least one engagement portion provided with at least one fastening mechanism configured to grip a portion of a pair of eyeglasses to hold the pair of eyeglasses in a predetermined position;
at least one supporting portion provided with at least one supporting surface configured to engage a destination surface of a frame of a bicycle and/or of a similar tubular body not forming part of the eyeglass-carrying device;
at least one locking element configured to operatively associate with the at least one supporting portion to keep the eyeglass-carrying device engaged to the destination surface of the frame of the bicycle and/or of the similar tubular body not forming part of the eyeglass-carrying device, the at least one locking element having a substantially elongated closed-loop structure configured to at least partially envelop the eyeglass-carrying device and to keep the eyeglass-carrying device engaged to the destination surface of the frame of the bicycle and/or of the similar tubular body not forming part of the eyeglass-carrying device; and
at least one fastening protuberance, arranged substantially at corners of a reference quadrilateral, configured to removably engage the at least one locking element and configured to lock the eyeglass-carrying device on the destination surface of the frame of the bicycle and/or of the similar tubular body not forming part of the eyeglass-carrying device;
wherein the at least one fastening protuberance is integrated at the at least one supporting portion, and
wherein the at least one fastening protuberance develops from the at least one supporting portion.

2. The eyeglass-carrying device of claim 1, wherein the at least one fastening mechanism of the at least one engagement portion comprises at least one pair of fastening appendages that develop from the at least one supporting portion to converge toward a common convergence point in which the fastening appendages are close to one another or in contact with each other, the fastening appendages diverging from one another going away from the convergence point and on an opposite side to the at least one supporting portion to define a facilitating groove for engagement of the portion of the eyeglasses not forming part of the eyeglass-carrying device, the fastening appendages delimiting, at least in part, a housing and locking seat of the portion of the eyeglasses to be fastened and held and being elastically deformable to allow insertion of the portion of the eyeglasses in a respective housing and locking seat or extraction of the eyeglasses from the housing and locking seat through an opening out of the fastening appendages, or of mobile parts of the fastening appendages, at the convergence point.

3. The eyeglass-carrying device of claim 1, wherein the at least one engagement portion comprises at least one housing and locking seat of the portion of the eyeglasses to be fastened and held, the at least one housing and locking seat being provided with at least one magnetic element configured to interact with a magnetic or ferromagnetic element present on the portion of the eyeglasses to be fastened to hold the eyeglasses according to a predetermined position.

4. The eyeglass-carrying device of claim 1, wherein the at least one supporting surface of the at least one supporting portion is arched concave shaped to engage an arched convex destination surface of the frame of the bicycle and/or a similar arched convex tubular portion not forming part of the eyeglass-carrying device.

5. The eyeglass-carrying device of claim 1, wherein the at least one supporting surface of the at least one supporting portion is flat to engage a flat destination surface of the frame of the bicycle and/or a similar flat tubular portion not forming part of the eyeglass-carrying device.

6. The eyeglass-carrying device of claim 1, wherein the at least one supporting surface of the at least one supporting portion has a variable configuration.

7. The eyeglass-carrying device of claim 6, wherein the at least one supporting surface with the variable configuration is defined on an elastically deformable supporting portion, an elasticity of the elastically deformable supporting portion giving to the elastically deformable supporting portion an ability to deform, allowing switching of the at least one supporting surface between an arched concave configuration and a flat configuration.

8. The eyeglass-carrying device of claim 1, further comprising:
at least one gasket or similar interposition element between the at least one supporting surface of the at least one supporting portion and the destination surface of the frame of the bicycle and/or the similar tubular body not forming part of the eyeglass-carrying device.

9. The eyeglass-carrying device of claim 8, wherein the at least one gasket or similar interposition element has:
a first surface; and
a second surface, facing away from the first surface, that is arched concave or flat or with variable configuration between an arched concave configuration and a flat configuration.

10. The eyeglass-carrying device of claim 9, wherein the at least one gasket or similar interposition element is made of an elastically deformable material configured to adapt to a first shape of the at least one supporting surface of the at least one supporting portion and to a second shape of the destination surface of the frame of the bicycle and/or the similar tubular body not forming part of the eyeglass-carrying device.

11. The eyeglass-carrying device of claim 1, wherein the at least one fastening mechanism of the at least one engagement portion is joined in one piece to the at least one supporting portion.

12. The eyeglass-carrying device of claim 1, wherein the at least one engagement portion provided with the at least one fastening mechanism is configured to be removably constrained to the at least one supporting portion.

13. The eyeglass-carrying device of claim 1, wherein the at least one supporting portion has a substantially circular shape from which the at least one fastening protuberance develops.

14. The eyeglass-carrying device of claim 1, wherein the at least one supporting portion has a substantially square or rectangular shape from which the at least one fastening protuberance develops.

15. The eyeglass-carrying device of claim 1, wherein the at least one locking element is configured to envelop at least partially the at least one fastening protuberance projecting from the at least one supporting portion of the eyeglass-carrying device.

16. A bicycle, comprising:
a frame; and
the eyeglass-carrying device of claim 1.

17. The eyeglass-carrying device of claim 1, wherein the at least one supporting portion is on an opposite side with respect to the at least one engagement portion.

18. The eyeglass-carrying device of claim 1, wherein the substantially elongated closed-loop structure comprises an O-ring seal.

19. The eyeglass-carrying device of claim 1, wherein the at least one fastening protuberance comprises two opposite fastening protuberances.

20. The eyeglass-carrying device of claim 1, wherein the at least one fastening protuberance comprises four fastening protuberances.
